(19) United States
(12) Patent Application Publication
(10) Pub. No.: US 2015/0298477 A1
(43) Pub. Date: Oct. 22, 2015

(54) Educational Graph Device

(71) Applicant: Ron Chinitz, Marina del Rey, CA (US)

(72) Inventor: Ron Chinitz, Marina del Rey, CA (US)

(73) Assignee: Lotec Enterprises, Marina del Rey, CA (US)

(21) Appl. No.: 14/256,707

(22) Filed: Apr. 18, 2014

(51) Int. Cl. B41K 1/36

(52) U.S. Cl. CPC B41K 1/36

(57) ABSTRACT

A graph making device comprises an outer casing having an upper portion and a lower portion, a button placed inside an opening on the upper portion of the outer casing, a support member placed inside the upper portion of the outer casing, the support member having a top portion and a bottom portion, a spring placed inside the upper portion of the outer casing between the button and the support member, wherein the spring is engaged around a projection on the top portion of the support member, an ink pad placed in between the top portion and the bottom portion of the support member, and a graph stamp placed in between the top portion and the bottom portion of the support member and below the ink pad. The graph stamp is configured to produce a Cartesian graph on a graphing paper by pressing the button.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE DISCLOSURE

This embodiment relates to mathematical graph tools, and more particularly to a graph making device that is capable of producing a Cartesian graph on paper by means of a self-inking graph stamp.

### DISCUSSION OF RELATED ART

The modern Cartesian coordinate system in two dimensions is defined by an ordered pair of perpendicular lines (axes). The lines are commonly referred to as the x and y-axes where the x-axis is taken to be horizontal and the y-axis is taken to be vertical. The point where the axes meet is taken as the origin for both, thus turning each axis into a number line. Heretofore in the plotting of graphs on a surface the common practice has been to draw by hand the coordinate axes on ruled coordinate paper or graph paper in accordance with the system of Cartesian coordinates.

In the case of school students, there is a need for drawing graphs repeatedly for the purpose of learning. The hand sketching of graphs on coordinate paper or graph paper is customarily done by freehand with pen or pencil and ruler. If there are a large number of graphs to be drawn, as in the case of school students, it becomes quite tedious and tiring. Furthermore, the hand sketching can become irregular causing an irregular graph.

In some existing graph sketching tools, a graph marking device that prints any one of a series of indicia or symbols on a graph in a precise position including a flexible ribbon bearing a plurality of graph marking indicia or symbols, manually adjustable means for manipulating the ribbon so as to select one of them for printing on the graph, and guide means to be aligned with the usual lines on the graph to indicate where the indicia or symbol will be printed when the device is operated. Some other existing graph tools, provide a plotting device for plotting points in a system of Cartesian coordinates comprising a pair of members set along coordinate scales to effect the setting of a marking member, which marking member when actuated after being thus set makes an appropriate symbol perforation or puncture on a sheet at a position corresponding to the coordinate setting of said members. However, such graph tools are used for either printing symbols on the graph or for plotting points on the graph and not for drawing the coordinate axes.

None of the existing graph-sketching tools provides the capability of automatically producing a Cartesian graph on paper without using hand sketching techniques. Such a device would save time and enhances the neatness and accuracy of the finished graph.

Therefore, there is a need for a new graph sketching device for self-sketching a Cartesian graph on paper without hand drawing. The new device would comprise a self-inking graph stamp and would solve the issue of students having to sketch graphs repeatedly. The device would save time and enhance the neatness and accuracy of the student's work. Moreover, the device would be adaptable to fit neatly into a student's pencil case. The present disclosure accomplishes these objectives.

### SUMMARY OF THE DISCLOSURE

The present embodiment is a graph making device that is capable of producing a Cartesian graph on paper without hand sketching. The graph making device comprises an outer casing having an upper portion and a lower portion. The upper portion and the lower portion are configured to be separated from each other during use. The device further comprises a button placed inside an opening on the upper portion of the outer casing, a support member placed inside the upper portion of the outer casing, a spring placed inside the upper portion of the outer casing in between the button and the support member, an ink pad placed in between a top portion and a bottom portion of the support member, and a graph stamp placed in between the top portion and the bottom portion of the support member.

The upper portion and the lower portion of the outer casing are separated and the upper portion is placed on a graphing paper with the graph stamp facing downward. Pressing the button produces a Cartesian graph on paper. The graph making device is self-inking and solves the issue of students having to sketch the graph repeatedly. The device saves time and enhances the neatness of the student's work. The graph making device is also designed to fit neatly into students pencil cases.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a perspective view of a graph making device in accordance with a preferred embodiment of the present invention;

FIG. 2 is a top view of the graph making device in accordance with the preferred embodiment of the present invention;

FIG. 3 is a bottom view of the graph making device in accordance with the preferred embodiment of the present invention;

FIG. 4 illustrates an upper portion of an outer casing of the graph making device in accordance with the preferred embodiment of the present invention;

FIG. 5 illustrates a lower portion of the outer casing of the graph making device in accordance with the preferred embodiment of the present invention;

FIG. 6 is an exploded view of the graph making device in accordance with the preferred embodiment of the present invention; and

FIGS. 7A-7B illustrates the graph making device in use.

### DETAILED DESCRIPTION OF THE PREFERRED EMBODIMENT

The following describes example embodiments in which the present invention may be practiced. This invention, however, may be embodied in many different ways, and the description provided herein should not be construed as limiting in any way. Among other things, the following invention may be embodied as methods or devices. The following detailed descriptions should not be taken in a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

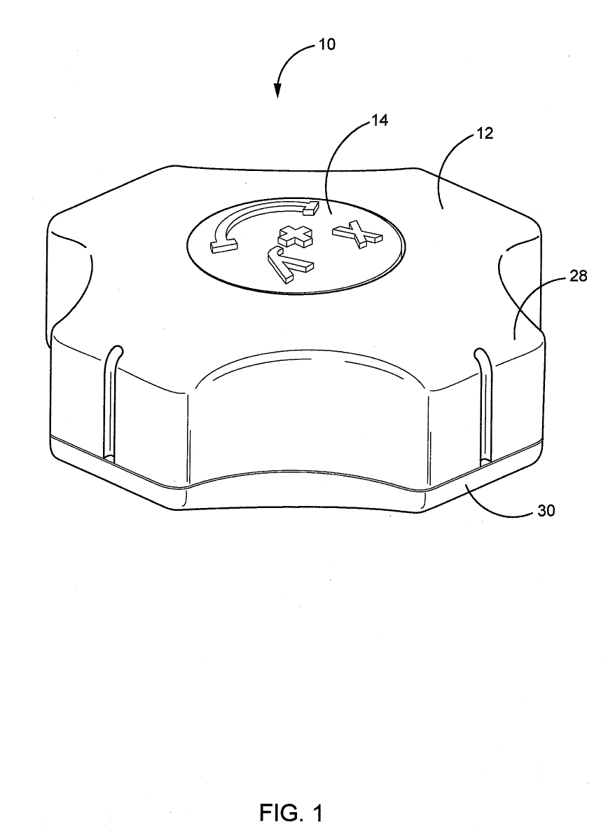

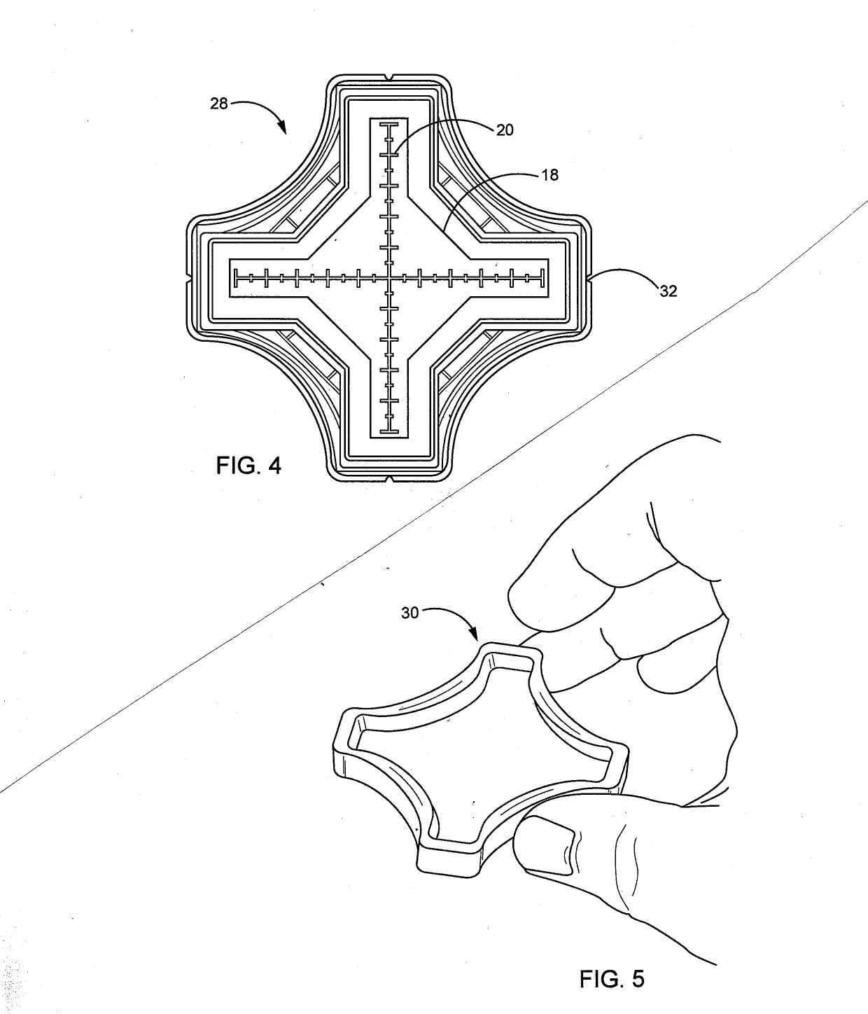

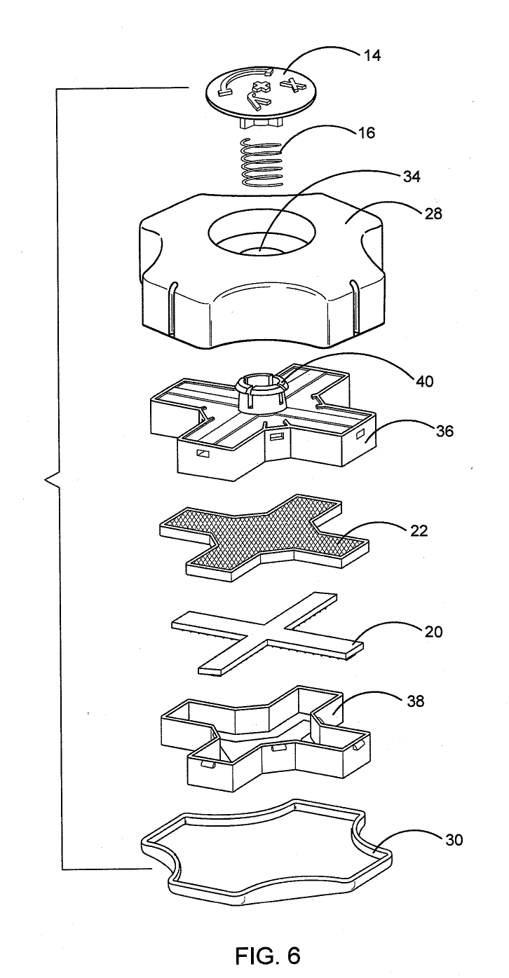

FIG. 1 is a perspective view of a graph making device 10 in accordance with a preferred embodiment of the present invention. The graph making device 10 comprises an outer casing 12, having a button 14, and enclosing a spring 16 (See FIG. 6), a support member 18 (See FIG. 4), a graph stamp 20 (See FIG. 4), and an ink pad 22 (See FIG. 6). The graph stamp 20 is configured to produce a Cartesian graph on a graphing paper by pressing the button 14.

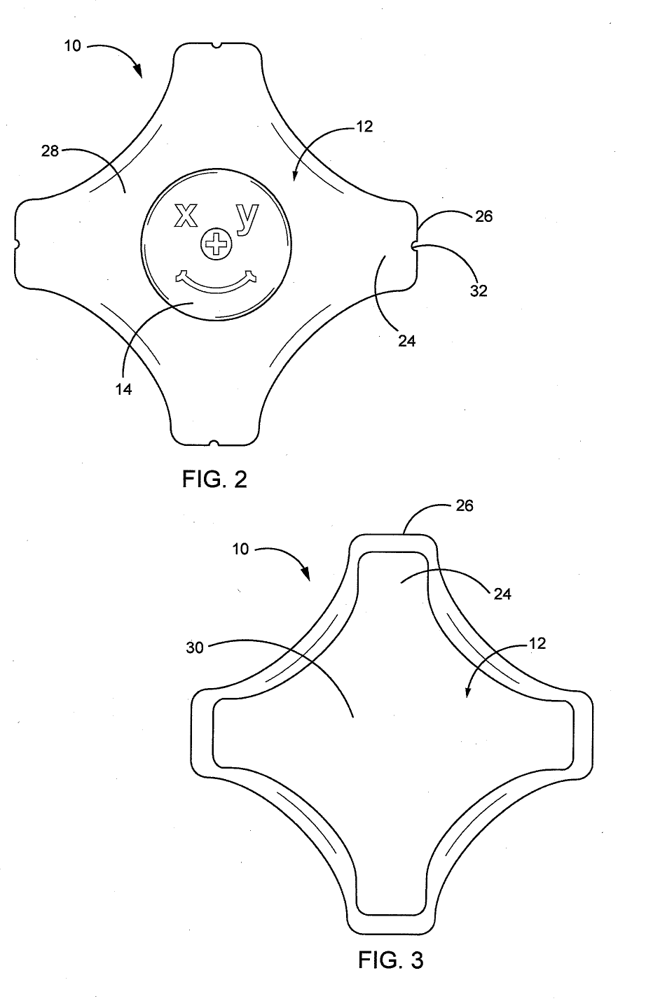

Referring to FIGS. 2 and 3, top and bottom views of the graph making device 10 are illustrated respectively. The outer casing 12 comprises a plurality of arms 24 on a pair of opposing sides 26 thereof. The outer casing 12 also has an upper portion 28 and a lower portion 30. The upper portion 28 and the lower portion 30 are configured to be separated from each other during use. The upper portion 28 further comprises a plurality of channels 32 at the tip of each of the plurality of arms 24 of the outer casing 12.

FIG. 4 illustrates the upper portion 28 of the outer casing 12 of the graph making device 10 in accordance with the preferred embodiment of the present invention. The upper portion 28 includes the button 14, the spring 16 (See FIG. 6), the support member 18, the ink pad 22 (See FIG. 6) and the graph stamp 20. The button 14 is placed inside an opening 34 (See FIG. 6) on the upper portion 28 of the outer casing 12. The support member 18 is placed inside the upper portion 28 of the outer casing 12 and includes a top portion 36 (See FIG. 6) and a bottom portion 38 (See FIG. 6). The spring 16 (See FIG. 6) is placed inside the upper portion 28 of the outer casing 12, in between the button 14 and the support member 18. The spring 16 (See FIG. 6) is engaged around a projection 40 (See FIG. 6) on the top portion 36 (See FIG. 6) of the support member 18.

The ink pad 22 (See FIG. 6) is placed inside the upper portion 28 of the outer casing 12 in between the top portion 36 and the bottom portion 38 of the support member 18. The graph stamp 20 is placed in between the top portion 36 and the bottom portion 38 of the support member 18, below the ink pad 22 (See FIG. 6). The graph stamp 20 and the ink pad 22 (See FIG. 6) are continuously in contact with each other thereby automatically inking the graph stamp 20. The graph stamp 20 has an impression of a Cartesian graph thereon which when touches a paper, produces a sketch of a Cartesian graph.

FIG. 5 illustrates the lower portion 30 of the outer casing 12 of the graph making device 10 in accordance with the preferred embodiment of the present invention. The lower portion 30 of the outer casing 12 covers the graph stamp 20 when the device 10 is not in use and prevents spreading of ink where not desired. For using the graph making device 10, the lower portion 30 of the outer casing 12 is removed from the upper portion 28 thereof. The upper portion 28 having the self-inked graph stamp 20 is placed on a graphing paper to obtain a Cartesian graph.

FIG. 6 is an exploded view of the graph making device 10 in accordance with the preferred embodiment of the present invention. For assembling the graph making device 10, first the button 14 is inserted into the spring 16 of the graph making device 10. The button 14 and the spring 16 together are then inserted into an opening 34 on the upper portion 28 of the outer casing 12. The ink pad 22 is inserted in between a top portion 36 and a bottom portion 38 of the support member 18 of the graph making device 10. The graph stamp 20 is inserted in between the top portion 36 and the bottom portion 38 of the support member 18 and below the ink pad 22. The support member 18 carrying the ink pad 22 and the graph stamp 20 inside is then inserted into the upper portion 28 of the outer casing 12 such that the spring 16 engages with a projection 40 on the top portion 36 of the support member 18. Finally, the upper potion 28 and the lower portion 30 of the outer casing 12 is attached together to form the graph making device 10. All the components are connected by locking mechanisms and without the use of any adhesive.

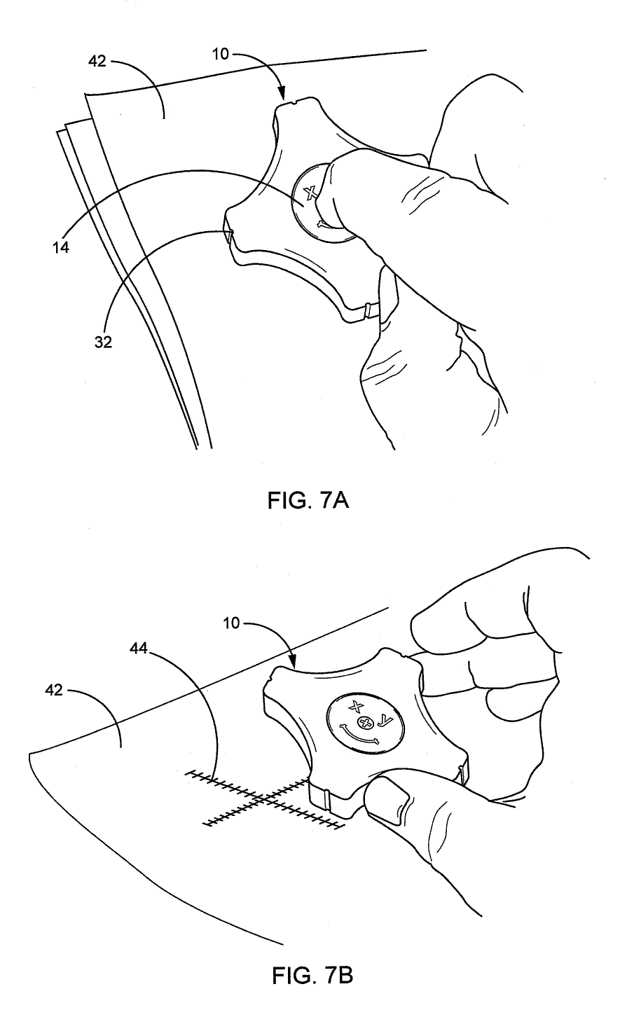

FIGS. 7A-7B illustrates the graph making device 10 in use. For using the graph making device 10, first the lower portion 30 of the outer casing 12 is removed from the upper portion 28 thereof. The upper portion 28 of the outer casing 12 is placed on a graphing paper 42 with the graph stamp 20 facing downward towards the paper 42. The graph making device 10 is moved to position on the paper 42 where the Cartesian graph is required to be drawn. The plurality of channels 32 at the tip of each of the plurality of arms 24 of the outer casing 12 align with lines in the graphing paper 42 and show a user where the graph will be created. The graph stamp 20 sits slightly above the graphing paper 42 when not in use enabling the device 10 to be moved across the graphing paper 42 without spreading ink where not desired.

After correcting the position of the graph making device 10, the button 14 is pressed to obtain a Cartesian graph as shown in FIG. 7A. When the button 14 is pressed, the spring 16 is compressed thereby pushing down the support member 18 and the graph stamp 20 towards the paper 42. The graph stamp 20, which is previously inked by being in contact with the ink pad 22, touches the paper 42 and produces an impression of a Cartesian graph 44 thereon. The graph making device 10 may then be moved to another position on the graphing paper 42 to produce another Cartesian graph. After use, the device 10 is closed, by covering the graph stamp 20 with the lower portion 30 of the outer casing 12 to prevent spreading of ink.

The present embodiment provides a self-inking graph making device 10 for use by math students and others. The graph making device 10 solves the issue of students having to sketch the graph repeatedly. The graph making device 10 saves time and enhances the neatness of the student's work. The graph making device 10 is also designed to fit neatly into students pencil cases. The graph making device 10 provides a small and convenient tool for making a Cartesian graph with a push of a button.

While a particular form of the invention has been illustrated and described, it will be apparent that various modifications can be made without departing from the spirit and scope of the invention. Accordingly, it is not intended that the invention be limited, except as by the appended claims.

What is claimed is:

1. A graph making device comprising:
an outer casing having an upper portion and a lower portion;
a button placed inside an opening on the upper portion of the outer casing;
a support member placed inside the upper portion of the outer casing, the support member having a top portion and a bottom portion;
a spring placed inside the upper portion of the outer casing between the button and the support member, wherein the spring is engaged around a projection on the top portion of the support member;
an ink pad placed in between the top portion and the bottom portion of the support member; and
a graph stamp placed in between the top portion and the bottom portion of the support member, and below the ink pad;
whereby the graph stamp being configured to produce a Cartesian graph on a graphing paper by pressing the button.

2. The graph making device of claim 1 wherein the outer casing comprises a plurality of arms on a pair of opposing sides thereof.

3. The graph making device of claim 1 wherein the upper portion of the outer casing further comprises a plurality of channels at the tip of each of the plurality of arms of the outer casing.

4. The graph making device of claim 3 wherein the plurality of channels align with lines in a graphing paper and show a user where the graph will be created.

5. The graph making device of claim 1 wherein the upper portion and the lower portion of the outer casing is separated during use.

6. The graph making device of claim 1 wherein the support member supports the ink pad and the graph stamp inside the upper portion of the outer casing.

7. The graph making device of claim 1 wherein the upper portion of the outer casing is placed on the graphing paper with the graph stamp facing downward and the button is pressed to obtain a Cartesian graph.

8. The graph making device of claim 1 wherein the graph stamp sits slightly above the graphing paper when not in use enabling the device to be moved across the graphing paper without spreading ink where not desired.

9. The graph making device of claim 1 is self-inking.

10. A self-inked graph making device comprising:
an outer casing having an upper portion and a lower portion, the outer casing further comprising a plurality of arms on a pair of opposing sides thereof, and a plurality of channels at the tip of each of the plurality of arms;
a button placed inside an opening on the upper portion of the outer casing;
a support member placed inside the upper portion of the outer casing, the support member having a top portion and a bottom portion;
a spring placed inside the upper portion of the outer casing between the button and the support member, wherein the spring is engaged around a projection on the top portion of the support member;
an ink pad placed in between the top portion and the bottom portion of the support member; and
a graph stamp placed in between the top portion and the bottom portion of the support member, and below the ink pad;
whereby placing the upper portion of the outer casing on a graphing paper with the graph stamp facing downward and pressing the button produces a Cartesian graph.

11. The self-inked graph making device of claim 10 wherein the upper portion and the lower portion of the outer casing is separated during use.

12. The self-inked graph making device of claim 10 wherein the plurality of channels align with lines in the graphing paper and show a user where the graph will be created.

13. The self-inked graph making device of claim 10 wherein the graph stamp sits slightly above the graphing paper when not in use enabling the device to be moved across the graphing paper without spreading ink where not desired.

14. A method for assembling a graph making device, the method comprising the steps of:
(a) providing the graph making device to a user;
(b) separating an outer casing of the graph making device to an upper portion and a lower portion thereof;
(c) inserting a button inside a spring of the graph making device;
(d) inserting the button and the spring into an opening on the upper portion of the outer casing;
(e) inserting an ink pad in between a top portion and a bottom portion of a support member of the graph making device;
(f) inserting a graph stamp below the ink pad and in between the top portion and the bottom portion of the support member of the graph making device;
(g) inserting the support member carrying the graph stamp into the upper portion of the outer casing such that the spring engages with a projection on the top portion of the support member; and
(h) attaching together the upper portion and the lower portion of the outer casing to form the graph making device.

15. The method of claim 14 wherein the upper portion and the lower portion of the outer casing is separated during use.

16. The method of claim 14 wherein the upper portion of the outer casing is placed on the graphing paper with the graph stamp facing downward and the button is pressed to obtain a Cartesian graph.
